(19) United States
(12) Patent Application Publication
(10) Pub. No.: US 2003/0172126 A1
(43) Pub. Date: Sep. 11, 2003

(54) Method and system for displaying condensed web page information in response to a user query

(75) Inventors: Joe Nathan Brown, Austin, TX (US); Corradino D. Jones, Austin, TX (US)

Correspondence Address: Andrew M. Harris, Weiss & Moy, P.C., 4204 North Brown Ave., Scottsdale, AZ, 85251-3914, US

(73) Assignee: International Business Machines Corporation, Armonk, NY

(21) Appl. No.: 10/093,435

(22) Filed: Mar. 7, 2002

(51) Int. Cl. G06F 15/16

(52) U.S. Cl. 709/217

(57) ABSTRACT

A method and system for displaying condensed web page information provides a powerful tool for enhancing Internet browsers and other web page display programs. In response to user selection of a hyperlink by a mechanism other than the mechanism normally used to activate the hyperlink, summary information is displayed for the web page represented by the hyperlink. A server retrieves information from the file corresponding to the web page associated with the hyperlink and extracts summary information, such as meta-tag summary information. The server then constructs an HTML page image and pushes the image to the requesting computer.

### BACKGROUND OF THE INVENTION

1. Technical Field

The present invention relates generally to networked computer systems, and more specifically, to a method and system for displaying condensed web page information within a computer system or network.

2. Description of the Related Art

Information technology is a constantly growing segment of business today. Network systems and recently the Internet and World-Wide-Web (WWW) have found increasing prominence in governments and business as well as personal lives. Internet browsers provide a user interface to a myriad of files located on servers, and the files represent web pages that can range from simple text displays to graphic and animation intensive displays that require a very large file transfer to display a completed page.

Internet browsing or “surfing” has become a significant portion of some individual's lives, both at work and at home. Search engines are often used by an Internet user to discover web sites (collections of web pages) and individual web pages that may contain information of interest to the user, but in some cases, the Internet user is within a website that presents one or more hyperlinks to other pages. Once a user has entered a web page display and especially when a user is viewing a page deeply nested within multiple levels of Web surfing it would be useful to the user to determine whether a hyperlink is worth activating, most notably when a long list of hyperlinks is presented.

Without activating a hyperlink, the user cannot determine whether or not the information within an associated web page is of interest, unless accurate information is presented describing the associated web page on the page where the hyperlink is embedded. The above lack of information regarding the value of activating a hyperlink leads to either wasted time and bandwidth as users activate hyperlinks to investigate the contents of the associated web pages, or missed opportunities and information when a user skips over a hyperlink.

Therefore, it would be desirable to provide a method and system for transporting and displaying condensed web page information for a hyperlink, without loading the associated web page.

### SUMMARY OF THE INVENTION

The above objective of displaying condensed web page information for a hyperlink is achieved in a method and system that provide a display of web page information without downloading the file for the web page associated with the hyperlink to a user's computer. The method and system may be implemented in an Internet browser containing a computer program product in accordance with an embodiment of the present invention.

The method and system display a web page on a graphical display coupled to a general-purpose computer system. The web page contains one or more hyperlinks to associated other web pages. When a user selects one of the hyperlinks, condensed web page information for the web page associated with the hyperlink is displayed.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting various network connections and computer systems in which embodiments of the invention may be practiced.

FIG. 2 is a block diagram depicting organization of computer programs implementing the methods of the present invention within the memories of the computer systems depicted in FIG. 1.

FIG. 3 is a flowchart depicting operation of a system as embodied in a method in accordance with an embodiment of the invention.

FIG. 4 is a pictorial diagram depicting graphical output of an Internet browser in accordance with an embodiment of the invention.

FIG. 5 is a pictorial diagram depicting graphical output of an Internet browser in accordance with an embodiment of the invention.

### DETAILED DESCRIPTION OF PREFERRED EMBODIMENT

The present invention provides improved network browsing through retrieval of condensed web page information, rather than downloading an entire web page file to a client computer. The condensed web page information is generally requested and displayed by operation of an improved Internet browser program executing within the client computer. The improved browser operates in conjunction with a server program that generates the condensed information display, generally in the form of an Hypertext Markup Language (HTML) document pushed from the server to the client computer. Various enhancements are provided to server programs and network browsers to support implementation of the invention. The invention may be implemented throughout the network or may be embodied within a single client/server connection and supported by further connections to other servers executing existing server programs.

In the exemplary embodiment, the condensed Web page information is generated from summary information provided in meta-tags within web page files. Presently, Internet servers support the HTTP (Hypertext Transfer Protocol) Head Request command and return the summary meta-tag information for the provided Universal Resource Locator (URL) in response to receiving the Head Request command. However, the present invention may utilize other information available within a network connection, including an entire web page file to produce condensed web page information for delivery to a client computer.

The condensed web page information provided by the exemplary embodiment of the present invention is in the form of a HTML document pushed from a server executing program instructions in accordance with an embodiment of the present invention. However, delivery of condensed web page information is not restricted to HTML delivery and may take the form of binary data delivered to a dedicated applet, such as a JAVA applet executable within the client computer, or other forms of data transfer that support a display of condensed web page information.

In contrast to search engine and web directory operation, which also typically provide a display of summary information for web pages, the present invention operates to provide one specific summary for a URL identified by a user. Search engines and directories provide multiple summaries, one associated with each search result and the summaries are associated with a result of a search performed on a search server and not a specific predetermined URL.

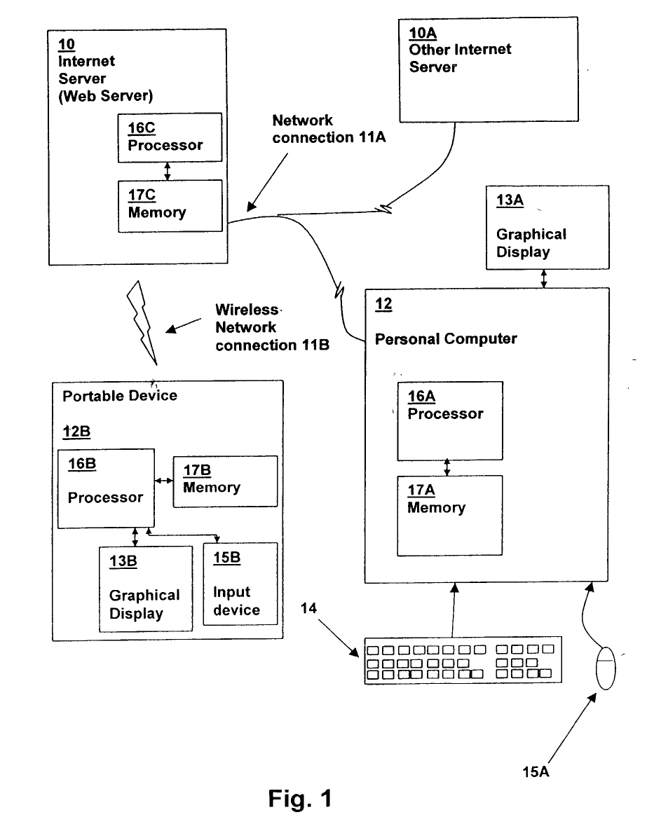

Referring now to the figures and in particular to FIG. 1, a networked computer system within which embodiments of the present invention are included is depicted in a block diagram. To support World Wide Web (WWW) surfing and other Internet functions an Internet server 10 is coupled to the Internet via a network connection 11A, along with other Internet servers including Other Internet Server 10A. Internet server 10 includes a server processor 16C, coupled to a server memory 17C for executing server program instructions from server memory 17C, wherein the server program instructions include program instructions for executing a method in accordance with an embodiment of the present invention. Also coupled to the Internet is a personal computer 12, having a processor 16A coupled to a memory 17A, for executing program instructions from memory 17A, wherein the program instructions include program instructions for executing a method in accordance with an embodiment of the present invention.

Personal computer 12 is coupled to a graphical display 13A for displaying program output such as Web browsers implementing embodiments of the present invention. Personal computer 12 is further coupled to input devices such as a mouse 15A and a keyboard 14 for receiving user input. The networked computer system may be coupled to a public network such as the Internet, or may be a private network such as the various “intra-nets” that are implemented within corporate offices and other installations requiring secure data communications.

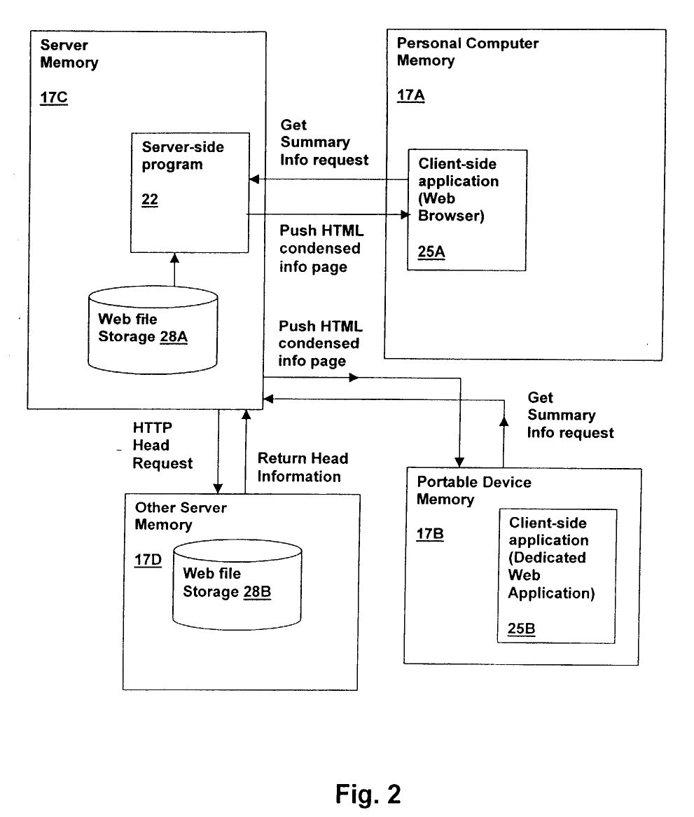

Within memory 17A, a network browser program (ref. 25A of FIG. 2) in accordance with an embodiment of the present invention general use is executing and thereby providing access to the Internet via network connection 11A. Browser code embodying a method in accordance with embodiments of the present invention is executed by processor 16A. Personal computer 12 is included to provide a demonstrative example of a general purpose computer, and it will be understood by those skilled in the art that the techniques of the present invention apply to a variety of other applications such as dedicated Internet appliances and large mainframe computers having user terminals.

The present invention also applies to personal appliances such as personal digital assistants (PDAs) and Internet-enabled pagers and cellular telephones. A second computing device, portable device 12B is shown coupled to Internet server 10 by a wireless network connection 11B. Portable device 12B may be a personal digital assistant (PDA) or another device adapted to provide a wireless and portable connection to the Internet (or other network), such as Internet-enabled cellular telephones, pagers, e-mail readers and the like. Portable device includes a processor 16B coupled to a memory 17B in which program instructions in accordance with an embodiment of the present invention are stored, whereby processor 16B executes program instructions implementing a method in accordance with an embodiment of the invention.

Referring now to FIG. 2, the organization of computer programs implementing methods of the present invention are depicted in a block diagram. Server memory 17C contains a server-side program 22 that communicates with a client-side application, in this case a Web browser 25A. Server side program 22 is generally a Computer Gateway Interface (CGI) program that is responsible for providing a response to the HTTP Head Request. Web Browser 25A receives a condensed information HTML page from server-side program 22 in response to a “Get Summary Info” request (or a direct HTTP head request) issued by Web Browser 25A in response to a user input. The advantage of using a direct HTTP head request command is that no extension need be made to the HTTP command set. Since the server can determine that the head request is coming from a browser (rather than another server or gateway), and browsers do not typically generate head requests for any other purpose, a protocol implementing the present invention may be designed within the standard HTTP command set. Therefore, server software may be written that produces a condensed web page info HTML document in response to a head request received from a browser.

The get summary info request (or head request) may be satisfied by retrieval of web page information from a local web file storage 28A that is coupled to server 10, or if the web page is remotely located in other server memory 17D (or web file storage 28B coupled to other server 10A), the condensed web page information may be retrieved by issuing a request from internet server 10 to other Internet server 10A. The request/return protocol may be a command supported by another Internet server 10A that implements a method in accordance with an embodiment of the invention. For example, other Internet server 10A may support a get summary info request and generate an HTML condensed information page that is then passed to internet server 10 and ultimately to Web Browser 25A. Alternatively, Internet server 10 may issue a standard HTTP Head request (or in some cases retrieve an entire web page file if the condensed web page information is to be based on more than the HTTP Head information) and server side program 22 may generate an HTML condensed information document from retrieved information.

Since connections between Internet servers will typically have higher bandwidth than connections between servers and client computers, an operational advantage is still provided if the entire web page file is used to generate the condensed web page information, as the entire web page file is not transferred over the typically lower-bandwidth connection to the client computer. In the general case, the transfer of the entire web page file between servers typically occurs when a client loads the entire web page. Therefore at least one transfer of the entire web page file is eliminated by operation of a method of the present invention.

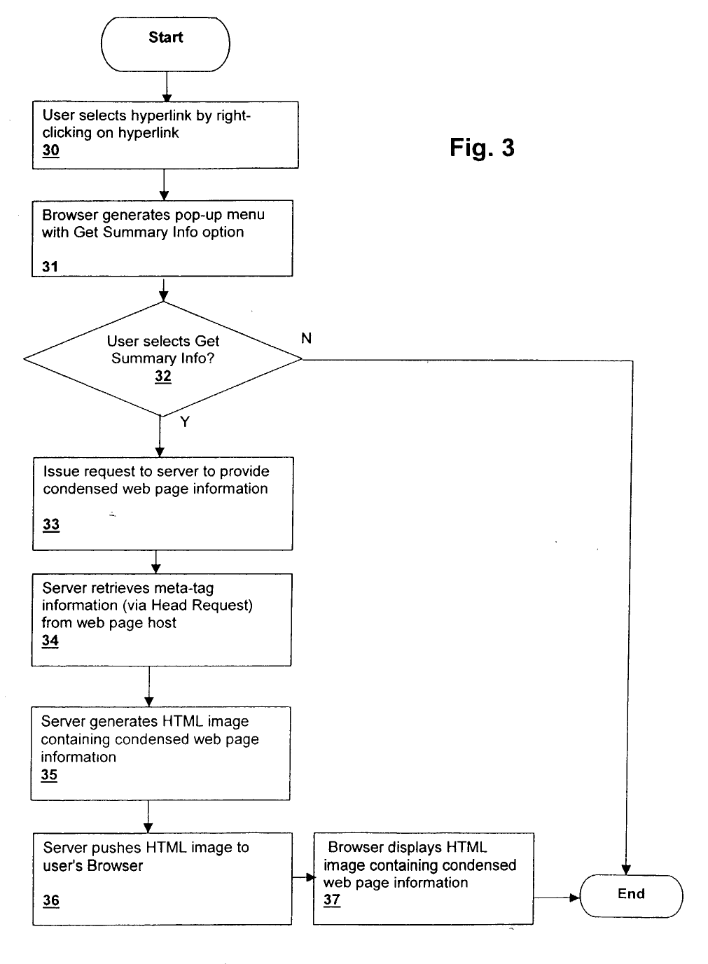

Referring now to FIG. 3, operation of a network in accordance with the present invention is depicted in a flowchart. When a user of Web Browser 25A or 25B selects a hyperlink by right-clicking above the hyperlink (step 30) (or performs another suitable selection of the hyperlink other than the action that would activate the loading of the entire web page), Web Browser 25A or 25B generates a pop-up menu that includes a “Get Summary Info” option (step 31). (Alternatively, step 31 may be skipped for implementations in which user input is assigned to automatically get the condensed web page information.) When the user selects the “Get Summary Info” option (decision 32), a request is issued to server-side program 22 to provide condensed web page information (step 33). Server side program 22 retrieves meta-tag information via an HTTP head request command to the server hosting the web page associated with the hyperlink (step 34). Alternatively, as described above, server side program 22 may retrieve other information such as the entire web page file, retrieve a local file containing the web page or summary information, or may forward the request to get condensed web page information if the network supports the get condensed web page information request.

Next, after the meta-tag or other information is retrieved, server side program 22 generates an HTML image containing the condensed web page information (step 35) and pushes the HTML image to web browser 25A or 25B (step 36). Alternatively, as described above, server side program 22 may transmit other information, such as binary data, to enable web browser 22 to generate a display of condensed web page information. Web browser then displays the HTML page (step 37) or other transmission, providing a rapid display of the web page contents.

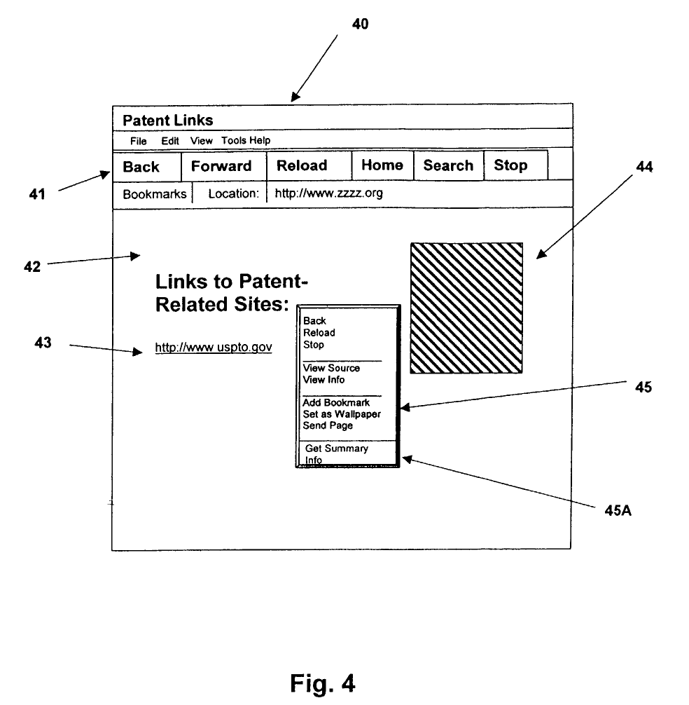

Referring now to FIG. 4, a graphical display of an output of web browser 25A in accordance with an embodiment of the invention is depicted. The graphical display depicted is in the form generally found within general-purpose computer system network browser outputs and the implementation for a PDA or other portable device may be particularly adapted for the type of display and user input sensing available within the device.

Browser graphical output 40, of a framework generally implemented in browsers currently installed on personal computers includes a toolbar and menu area 41 for interacting with the Internet and World-Wide-Web and for control of program features. A display area 42 displays contents of a web page including hyperlinks 43 and 44 for which condensed web page information may be retrieved in accordance with an embodiment of the present invention. Hyperlink 44 is an example of a hyperlinked graphical object, which may be an image, an icon, a button, et cetera. When a user selects hyperlink 43 or 44 by right clicking over hyperlink 43 or 44 (or other suitable selection mechanism), pop-up menu 45 is displayed, including a Get Summary Info option 45A. If the user selects the get summary info option, web browser 25B will retrieve the condensed web page information.

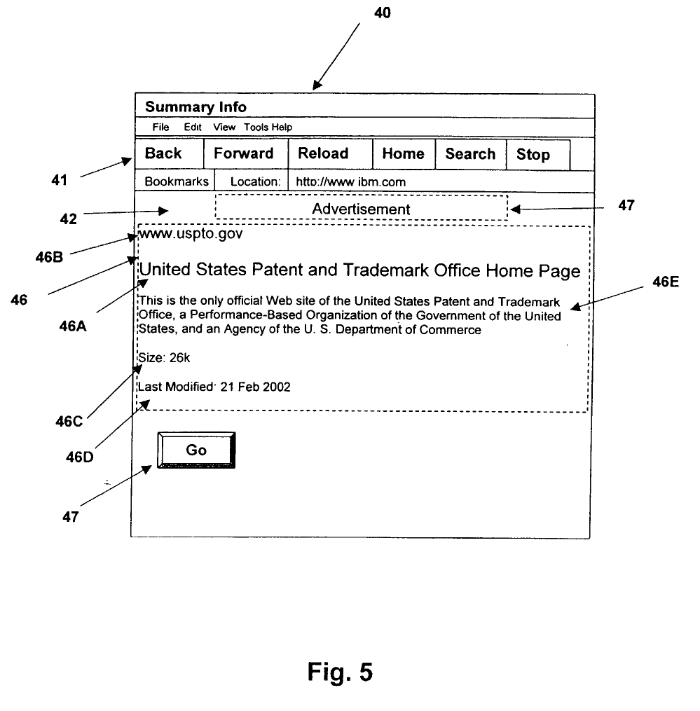

Referring now to FIG. 5, a graphical display of an output of web browser 25B in accordance with an embodiment of the invention is depicted. Display area 42 now contains condensed web page information 46 provided by a method in accordance with the present invention. The condensed web page information shown is exemplary and represents the type of information that may be displayed with meta-tag information retrieved by an HTTP Head Request command, but it should be understood that condensed web page information 46 could contain other information that may be accessed by other mechanisms. Information within condensed web page information 46 includes the URL of the web page 46B, the title of the web page 46A, the description meta-tag information 46E, the size of the web page file 46C and the date on which the file was last modified 46D. By providing the above-listed information, a user can improve the speed of web browsing by deciding whether or not to load the entire web page (by selecting “go” button 47) based on the size, description and age of the web page file. An advertisement 48 may be added to the display of condensed web page information, providing a motivation for hosting services to add the enhancements of the present invention to their servers.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for displaying web page information within a general-purpose computer system, comprising:
displaying a parent web page on a graphical display coupled to said general-purpose computer system, said parent web page display containing one or more hyperlinks to associated other web pages;
detecting a user selection of a given one of said hyperlinks;
in response to detecting selection of said given hyperlink, retrieving condensed web page information of a given web page associated with said selected hyperlink; and
second displaying said condensed web page information on said graphical display.

2. The method of claim 1, further comprising retrieving meta-tag information from a file corresponding to said other web page, and wherein said second displaying displays a portion of said meta-tag information.

3. The method of claim 1, further comprising:
generating a condensed web page file image for displaying said condensed web page information of said other web page; and
transmitting said condensed web page file image to said general-purpose computer system, and wherein said second displaying displays said condensed web page file image.

4. The method of claim 3, further comprising:
in response to said user selecting said given hyperlink, transmitting a request for condensed web page information to a server; and
retrieving information from a file corresponding to said given web page, and wherein said generating generates said condensed web page information at said server in conformity with said retrieved information.

5. The method of claim 4, wherein said generating generates an HTML file image containing said condensed web page information, and said transmitting pushes said HTML file image from said server to said general-purpose computer.

6. The method of claim 4, wherein said retrieving retrieves meta-tag information from a said file corresponding to said given web page.

7. The method of claim 1, wherein said detecting detects that said user has moved a graphical cursor over said hyperlink and that said user has further selected said hyperlink by activating an input button associated with said graphical cursor, wherein said method further comprises:
displaying a pop-up menu containing a get summary option for requesting said condensed web page information; and
detecting user selection of said get summary option, and wherein said retrieving and displaying of said condensed web page information are performed in response to said detected selection of said get summary option.

8. The method of claim 1, wherein said displaying said parent web page displays said parent web page in a first window, and wherein said second displaying displays said condensed web page information in a second pop-up window.

9. The method of claim 1, wherein said retrieving further comprises:
transmitting an HTTP head request to a server from said general-purpose computer;
in response to receiving said HTTP head request, determining whether or not said HTTP head request originated from a browser;
in response to determining said HTTP head request originated from said browser, generating a condensed web page information HTML document; and
transmitting said condensed web page information HTML document to said general-purpose computer, whereby said displaying displays said condensed web page information HTML document.

10. A computer network comprising a general-purpose computer including a memory for storing program instructions and data, a processor coupled to said memory for executing said program instructions, a graphical display coupled to said processor for displaying a graphical user interface (GUT) and an input device coupled to said processor for providing user input, said network further comprising a server coupled to said general-purpose computer including a server memory for storing program instructions and data, a server processor coupled to said server memory for executing said server program instructions, wherein said program instructions within said general-purpose computer comprise program instructions for:
displaying a parent web page on a graphical display coupled to said general-purpose computer system, said parent web page display containing one or more hyperlinks to associated other web pages;
detecting a user selection of a given one of said hyperlinks;
in response to detecting selection of said given hyperlink, generating a request to said server for retrieving condensed web page information of a given web page associated with said selected hyperlink;
receiving said condensed web page information from said server; and
second displaying said condensed web page information on said graphical display.

11. The computer network of claim 10, wherein said server program instructions comprise program instructions for:
receiving said request from said general-purpose computer to retrieve condensed web page information;
retrieving condensed web page information from a file corresponding to said other web page; and
transmitting said condensed web page information to said general purpose computer.

12. The computer network of claim 11, wherein said server program instructions for retrieving retrieve meta-tag information from said file.

13. The computer network of claim 11, wherein said server program instructions further comprise server program instructions for generating a condensed web page file image for displaying said condensed web page information of said other web page, and wherein said server program instructions for transmitting transmit said condensed web page file image to said general-purpose computer system, and wherein said second displaying displays said condensed web page file image.

14. The computer network of claim 11, wherein said server program instructions further comprise program instructions for determining whether or not said request originated from a browser, and said program instructions for retrieving and transmitting are executed in response to determining that said request originated from a browser.

15. The computer network of claim 13, wherein said server program instructions for generating generate an HTML file image containing said condensed web page information, and said server program instructions for transmitting push said HTML file image from said server to said general-purpose computer.

16. The computer network of claim 11, wherein said program instructions for detecting detect that said user has moved a graphical cursor over said hyperlink and that said user has further selected said hyperlink by activating an input button associated with said graphical cursor, and wherein said program instructions within said general-purpose computer further comprise program instructions for:
displaying a pop-up menu containing a get summary option for requesting said condensed web page information; and
detecting user selection of said get summary option, and wherein said program instructions for requesting said condensed web page information are performed in response to said detected selection of said get summary option.

17. The computer network of claim 11, wherein said program instructions for displaying said parent web page display said parent web page in a first window, and wherein said program instructions for second displaying display said condensed web page information in a second pop-up window.

18. A computer program product comprising signal-bearing media encoding program instructions for execution within a general-purpose computer system coupled to a network including a server, wherein said program instructions comprise program instructions for:
displaying a parent web page on a graphical display coupled to said general-purpose computer system, said parent web page display containing one or more hyperlinks to associated other web pages;
detecting a user selection of a given one of said hyperlinks;
in response to detecting selection of said given hyperlink, generating a request to said server for retrieving condensed web page information of a given web page associated with said selected hyperlink;
receiving said condensed web page information from said server; and
second displaying said condensed web page information on said graphical display.

19. The computer program product of claim 18, wherein said program instructions for detecting detect that said user has moved a graphical cursor over said hyperlink and that said user has further selected said hyperlink by activating an input button associated with said graphical cursor, and wherein said program instructions within said general-purpose computer further comprise program instructions for:
displaying a pop-up menu containing a get summary option for requesting said condensed web page information; and
detecting user selection of said get summary option, and wherein said program instructions for requesting said condensed web page information are performed in response to said detected selection of said get summary option.

20. The computer program product of claim 18, wherein said program instructions for displaying said parent web page display said parent web page in a first window, and wherein said program instructions for second displaying display said condensed web page information in a second pop-up window.

21. A computer program product comprising signal-bearing media encoding server program instructions for execution within a server coupled to a general-purpose computer system via a network, wherein said program instructions comprise server program instructions for:
receiving a request from said general-purpose computer to retrieve condensed web page information for a predetermined web page;
retrieving said condensed web page information from a file corresponding to said predetermined web page;
transmitting said condensed web page information to said general purpose computer.

22. The computer program product of claim 21, wherein said server program instructions for retrieving retrieve meta-tag information from said file.

23. The computer program product of claim 22, wherein said server program instructions further comprise server program instructions for generating a condensed web page file image for displaying said condensed web page information of said predetermined web page, and wherein said server program instructions for transmitting transmit said condensed web page file image to said general-purpose computer system.

24. The computer program product of claim 22, wherein said server program instructions further comprise program instructions for determining whether or not said request originated from a browser, and said program instructions for retrieving and transmitting are executed in response to determining that said request originated from a browser.

25. The computer program product of 23, wherein said server program instructions for generating generate an HTML file image containing said condensed web page information, and said server program instructions for transmitting push said HTML file image from said server to said general-purpose computer.
